(19) United States
(12) Patent Application Publication
(10) Pub. No.: US 2012/0148749 A1
(43) Pub. Date: Jun. 14, 2012

(54) MASKING TAPE FOR COMPOSITE MATERIALS

(75) Inventors: Jeffrey Michael Howe, Blue Springs, MO (US); Thomas Moody Belcher, JR., Dupo, IL (US); Jamie Marie Bass, Waterloo, IL (US)

(73) Assignee: BUDNICK CONVERTING, INC., Columbia, IL (US)

(21) Appl. No.: 13/324,547

(22) Filed: Dec. 13, 2011

Related U.S. Application Data
(60) Provisional application No. 61/422,834, filed on Dec. 14, 2010.

(51) Int. Cl. B05D 1/32; B32B 38/04; B05C 17/06

(52) U.S. Cl. 427/282; 118/505; 156/257

(57) ABSTRACT

A masking product for masking a composite material object comprising a substantially flat liner, a first tape layer on the liner having a width less than a width of the liner and defining a margin of liner along one edge of the first tape layer, the first tape layer defining a longitudinal cut dividing the first tape layer into a first segment and a second segment; and a second tape layer on the first tape layer and extending the length thereof, the second tape layer having a width less than the width of the first tape layer. In one aspect, the first segment of the first tape layer has a width less that the width of the second segment of the first tape layer.

### CROSS-REFERENCE TO RELATED APPLICATIONS

This application claims the benefit of provisional application Ser. No. 61/422,834, filed Dec. 14, 2010, which is incorporated herein by reference.

### STATEMENT REGARDING FEDERALLY SPONSORED RESEARCH

Not Applicable.

### BACKGROUND OF THE INVENTION

The invention relates generally to paint/coating masking for composite materials and more specifically to a masking product for use in masking composite materials, particularly composite materials comprising multiple material coatings of different colors

The process of paint/coating masking for composite materials requires specialty masking tapes, a high degree of professional skill and is very time consuming. Unlike the paint masking of traditional solid materials, composite materials are made of a series of layers and resins, exposed to mold release agents, and paints are introduced through thick gel coatings. One example of such composite material is fiberglass, or laminated fiberglass, such as fiberglass used in the marine industry, usually employing a gel coat layer on the fiberglass. Often the layers are of different colors and the manufacturers desire to have different colors abutting each other, striping or other designs.

Currently, composite masking professionals purchase many brands, types and sizes of masking tapes. Typical rolls of masking tape are ⅛, ¼, ½, ⅝, ¾, 1 and 2 inches wide. Masking professionals apply the tape on these self-wound, individual rolls one at a time. Depending on the look they are trying to create or the break line desired maskers sometimes carefully overlap rolls on top of one another. This overlapping allows them to remove one layer of masking tape to pull through the thick gel coat while the lower layer of protection remains. Evenly aligning these rolls while overlapping them can be difficult and time consuming, increasing the cost of the final product. Furthermore, many masking tapes are difficult to de-mask after being overlapped. Improper masking or removal can result in “spider-webbing” of the coating material along the masked line, which is undesirable.

One representative aspect of a narrow width masking product developed and sold by the assignee of this patent application is a “stacked” masking. This product is created by laminating two tapes on top of each other, die cutting lanes of masking, and stripping out unneeded material. The product is provided as a paper backed masking in self-wound rolls as a ⅛ inch wide strip stacked onto a ¼inch wide roll. The masking is applied and a layer of resin or colored gel resin is applied. The first layer or narrower strip of tape is pulled through the resin gel and then the second. This has some benefit in preventing spider webbing and although the “stacked” masking product is an improvement over other masking products known in the art, due to the stacked arrangement, it does not have any particular utility when applying layers of coats of resin gel of multiple colors, as desired in many applications, such as fiberglass boat hulls.

One known way of masking an object, such as a boat hull, for the application of layers of different color resin gels generally includes applying a first layer of tape all the way around the boat mold to create a site line for the first true masking layer; applying a first true masking layer, for example a ⅜ inch wide tape, near the site line all the way around the mold; removing the site line tape; applying a second, narrower masking tape, for example 1/4 inch wide, butted against the first masking tape all the way around the mold; applying a wider third masking tape, for example, ½ inch wide evenly aligned with an edge of the first masking tape over the first and second masking tapes so as to cover ⅛″ of the ¼″ masking tape; spray color 1 gel coat resin onto the mold and over the tape; remove the ½″ top cover tape through the gel coat resin; spray color 2 gel coat resin onto the mold and over the remaining lower layer tapes; remove lower layer ¼″ masking tape through the gel coat resin; spray color 3 gel coat resin onto the mold and over the remaining tape; and remove lower layer ¼″ masking tape through the gel coat resin.

As can be appreciated, the known methods of masking an object comprising a composite material, in this case, a boat hull, are tedious and time consuming, requiring the application of at least three separate, perfectly aligned layers of masking tape. Such a labor intense process can add a significant amount of costs to the final product

It would be desirable, therefore, to have a masking product that can be used to mask an object comprising a composite material, such as a fiberglass boat hull, that is economical to manufacture, simple to use, requiring less time to apply and remove than conventional masking products.

### SUMMARY OF THE INVENTION

A masking product for masking an object constructed from a composite material comprising a substantially flat, elongated liner, a first tape layer on the liner having a width less than the width of the liner, the first tape layer extending the length of the liner and having a longitudinal cut therein dividing the first tape layer into a first segment and a second segment, and a second tape layer on the surface of the first tape layer and extending the length thereof, the second tape layer having a width less than the width of the first tape layer. The first and second segments of the first layer can have different material widths.

A method of making the masking product.

A method of using the masking product.

### BRIEF DESCRIPTION OF THE DRAWING

FIG. 1 is a top plan view of the masking product of the present invention.

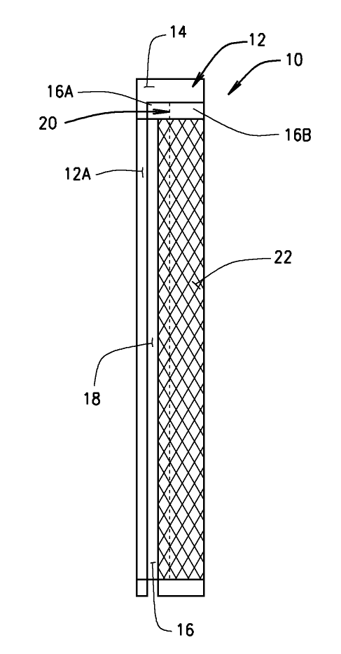

### DETAILED DESCRIPTION

The masking product of the present invention is indicated generally by reference number 10 in the drawing figure. Masking product 10 includes a liner 12. In the illustrated embodiment, liner 13 is a flexible paper liner has a width of about ¾ inch. Liner 12 has a substantial longitudinal dimension with top surface 14 and is generally is formed from a paper stock or roll, as known to the art, and cut to a desired size. There is a first layer 16 removably attached to the top surface 14 of liner 12. In the illustrated embodiment, first layer 16 extends the length of the liner and is positioned on the liner such that the right edge of layer 16 is in alignment with the right edge of the liner. In the illustrated embodiment, first layer 16 is a masking tape, as known to the art, and has a top surface 18 and a bottom surface releasably affixed to the liner by use of an appropriate adhesive. Layer 16, in the representative embodiment, is approximately ⅝ inch wide.

It will be appreciated that, in one aspect of the invention, when the ⅝ inch first layer is positioned on the ¾ inch liner, there is a ⅛ inch margin 12A of liner 12 extending the length of the masking product. The masking product, however, can be manufactured without a margin. There is a very narrow longitudinal cut or score 20 extending the length of first layer 16 effectively severing second layer 16 into two side-by-side segments 16A and 16B. In one aspect, the two segments have different widths; in the illustrated embodiment, the first segment 16A is approximately ¼ inch wide and the second segment 16B is approximately ⅜ inch wide. However, the two segments can have the same width.

Masking product 10 also includes a second layer 22 on top of the first layer. Second layer 22, as shown, is approximately ½″ wide. In the illustrative embodiment, second layer 22 is a masking tape releasably adhered to the top surface of first layer 16. As shown, the ½ inch wide second layer is positioned on top of the first layer and evenly aligned the right edge of segment 16B of the first layer, so as to expose ⅛″ of the ¼″ segment 16A of the first layer and the ⅛″ margin 12A of liner 12. As shown, the ⅜″ segment 16B of first layer 16 is fully covered by the wider ½″ second layer 22 and ⅛″ of the ¼″ segment 16A of the first layer side is covered.

The product is used as follows:
1) Maskers hand apply the novel masking product 10 of the present invention all the way around an object to be masked, for example, an object molded from a composite material such as a boat hull mold
2) Technicians spray a first color (i.e. color 1 gel coat resin) onto the mold and over masking product 10
3) Maskers remove the ½″ wide second layer 22 through the gel coat resin
4) Technicians spray a second color (i.e. color 2 gel coat resin) onto the mold and over the remaining first layer 16, comprising first segment 16A and second segment 16B
5) Maskers remove the segment 16A of the first layer of masking tape (i.e. the ¼″ wide segment of first layer 16) through the gel coat resin
6) Technicians spray a third color (i.e. color 3 gel coat resin) onto the mold and over the remaining segment 16B of first layer 16
7) Maskers remove the ⅜″ wide segment 16B masking tape through the gel coat resin

It will be appreciated that the masking product of the present invention presents a significant improvement in efficiency, requiring only one application of tape around the boat hull.

Masking product 10 is produced by scoring through a ⅝″ masking tape with liner to create the ⅜″ and ¼″ segments or strips that butt together on a common liner. Then, another ½″ strip is laminated on top of the first layer, so as to leave ⅛″ of the ¼″ segment uncovered. These three individual sizes are generally provided as one roll of tape layered together on a common liner and already properly aligned for production masking. The rolls can be any desired and convenient length, for example, 60 yards long.

More specifically:

The following tooling is employed:
1) RD80, 48 tooth, pressure sensitive scoring tool with 3 blades across at ¾″
2) RD90, 48 tooth, 10 blade multi-level scoring tool
   3 pressure sensitive (ps) blades to top layer of masking tape at ¾″ apart-starting ¼″ from metal to metal (mtm) blade
   3 ps blades through both layers to liner at ¾″ apart-starting ⅛″ from mtm
   4 mtm blades at ¾″ apart

One representative embodiment of a process for producing the tape is as follows:
1) The liner is flexographically printed with branding information.
2) One 72 mm wide roll of paper masking is laminated to a 3.25″ wide release paper liner roll. Tool #1, above, pressure sensitive cuts through the lower layer of tape ¾″ wide. From a second station, another roll of tape (72 mm wide) is laminated to the non-adhesive side of the lower layer of the original tape. Tool #2, above, then metal to metal and pressure sensitive cuts the multiple layers of tape. The non-essential tape matrix is removed from the final product as it is being rewound into its final roll presentation. The final product is a ¾″ (with x-liner) wide roll by 60 yards long.

It will be appreciated by those skilled in the art that the masking product described and shown is representative of the broader aspects of the invention and represents the best mode of working the invention presently known to the inventors. The relative dimensions of the masking product layers are representative of one useful embodiment. Although a representative embodiment comprising defined lengths and layer widths has been found to work satisfactory, the principles of the invention can be incorporated into a masking product having any desired length and widths of the liner and layers. The present invention encompasses multiple widths of masking tapes presented in various alignments, but as one roll of tape layered together on a common liner and already properly aligned for production masking of composite materials.

The masking product of the present invention saves a significant amount of preparation and paint/coating masking time. It also helps improve quality by reducing “spider web” flaws created during de-mask. It is understood that the novel “side-by-side” masking product of the present invention could save four to five masking trips around a boat, for example, and could increase production by approximately 10 to 20% per day.

The masking product can be customized to many brands, styles and finished product sizes and configurations. In general, the masking product and process of making same improves the consistency of masking layers alignment which increases the paint/coating break line quality. The layers of the tape are de-masked one at a time to improve the look and quality by removing excess coating/paint which prevents “spider web” flaws and rework time. Furthermore, rolls of the masking product of the present invention are easier for the masker to handle because desired lengths are easily pulled away from the roll and can be better aligned. The masking product allows manufacturers of composite materials to significantly increase production speeds and provide higher quality finished products.

1. A masking product for masking a composite material object, comprising:
a substantially flat liner;
a first tape layer on the liner, the first tape layer defining a longitudinal cut therein, said first tape layer divided into a first segment and a second segment; and
a second tape layer on the first tape layer and extending the length thereof, the second tape layer having a width less than the width of the first tape layer.

2. The masking product of claim 1 wherein the first tape layer has a width less than a width of the liner defining a margin of liner along one edge of the first tape layer

3. The masking product of claim 1 the first segment of the first tape layer has a width less that the second segment of the first tape layer.

4. The masking product of claim 2 wherein the liner has a width of approximately ¾inch, the first tape layer has a width of approximately ⅝ inch and the second tape layer has a width of approximately ½ inch.

5. The masking product of claim 1 wherein the first segment of the first tape layer has a width of approximately ¼ and the second segment of the first tape layer has a width of approximately ⅜ inch.

6. A method of making a masking product, comprising the steps of:
positioning a masking tape having a liner on a cutting apparatus;
scoring the masking tape down to the liner to create two side-by-side segments of masking tape on the liner; and
laminating a second masking tape on top of the first masking tape, said second masking tape having a width less than the width of the first layer of masking tape.

7. The method of claim 6 wherein the step of scoring the masking tape down to the liner to create two side-by-side segments of masking tape on the liner further comprises scoring the masking tape down to the liner to create a first segment having a first width and a second segment having a second width greater than the first width.

8. A method of masking an object and applying a resin, comprising:
applying a masking product all the way around a surface of the object, the masking product comprising a substantially flat liner, a first tape layer on the liner, the first tape layer having a first segment and a second segment, and a second tape layer on the first tape layer and extending the length thereof, the second tape layer having a width less than the width of the first tape layer;
spraying a first gel coat resin onto the surface of the object and over masking product;
removing the second tape layer through the gel coat resin;
spraying a second gel coat resin onto the surface of the object and over the remaining first tape layer;
removing the first segment of the first tape layer through the gel coat resin;
spraying a third gel coat resin onto the surface of the object and over the remaining segment of the first tape layer; and
removing the second segment of the first tape layer through the gel coat resin.
